(19) United States
(12) Patent Application Publication
(10) Pub. No.: US 2025/0380067 A1
(43) Pub. Date: Dec. 11, 2025

(54) SOLID-STATE IMAGING DEVICE AND METHOD OF INSPECTING SOLID-STATE IMAGING DEVICE

(71) Applicant: Samsung Electronics Co., Ltd., Suwon-si (KR)

(72) Inventor: Yasutaka KIMURA, Yokohama (JP)

(73) Assignee: Samsung Electronics Co., Ltd., Suwon-si (KR)

(21) Appl. No.: 19/230,835

(22) Filed: Jun. 6, 2025

(30) Foreign Application Priority Data
Jun. 6, 2024 (JP) 2024-091970
Oct. 25, 2024 (KR) 10-2024-0147935

(51) Int. Cl. H04N 25/772; H04N 25/533; H04N 25/60; H04N 25/78

(52) U.S. Cl. CPC H04N 25/772; H04N 25/533; H04N 25/60; H04N 25/78

(57) ABSTRACT

A solid-state imaging device includes a pixel array comprising a plurality of pixels oriented in a matrix; a pixel control unit configured to control operations of the plurality of pixels, the control of operations of the plurality of pixels including at least setting different exposure times for each pixel row of at least one pixel row of the pixel array; an analog-to-digital (AD) converter configured to perform AD conversion processing, the AD conversion processing including at least converting a pixel signal into a digital signal, the pixel signal being output from the pixel array, the pixel array including pixel rows exposed for different exposure times; and a data output unit configured to output the digital signal to the outside as image data.

### CROSS-REFERENCE TO RELATED APPLICATION

This application is based on and claims priority under 35 U.S.C. § 119 to Korean Patent Application No. 10-2024-0147935, filed on Oct. 25, 2024, in the Korean Intellectual Property Office, and Japanese Patent Application No. 2024-091970, filed on Jun. 6, 2024, in the Japan Patent Office, the disclosures of which are incorporated by reference herein in their entirety.

### BACKGROUND

Inventive concepts relate to, for example, a solid-state imaging device and/or to methods of inspecting and/or imaging using the solid-state imaging device.

A solid-state imaging device may, for example, receive light incident from a subject and photoelectrically convert the received light to generate an electrical signal. For example, a solid-state imaging device may include a CMOS image sensor, etc. A solid-state imaging device may perform analog-to-digital (AD) conversion processing to convert an analog signal output from a light-receiving element such as, for example, a photodiode, into a digital signal. Hereinafter, analog-to-digital conversion processing may be referred to as AD conversion processing.

A solid-state imaging device may use a technology for changing the slope (e.g., gain) of a reference signal during AD conversion processing. When the slope of the reference signal is used during AD conversion processing, the time taken to invert the magnitude relationship between the analog signal, output from a pixel, and the reference signal generated by a reference signal generation unit may be accelerated, and the time required for AD conversion processing may be shortened.

However, when the slope of a reference signal is used during AD conversion processing, if the output signal after AD conversion processing does not have linearity characteristics, correction processing for correcting the output signal may be performed. It may be advantageous to check whether the output signal after correction processing has appropriate linearity characteristics.

As a method of checking whether the output signal of a solid-state imaging device has appropriate linearity characteristics, a gradient image may be captured by the solid-state imaging device and the captured image may be checked. However, capturing the gradient image by using the solid-state imaging device may be difficult because the preparation of imaging conditions, etc. may be complicated and take time.

Meanwhile, in addition to the method of capturing the gradient image by using the solid-state imaging device, there are methods of generating the gradient image by similarly generating an analog signal (pixel signal) using a voltage source and inputting the analog signal to an AD converter. Such methods may utilize a separate power circuit (e.g., a digital to analog converter (DAC) circuit) to perform accurate inspection, and relatively increase costs.

### SUMMARY

Inventive concepts relate a solid-state imaging device capable of performing analog-to-digital (AD) conversion processing on a pixel signal output from pixels exposed at different exposure times by setting the different exposure times for each of at least one pixel row of a pixel array, and/or to methods of inspecting the solid-state imaging device. The inventive concepts may relate to a solid-state imaging device capable of relatively easily and relatively inexpensively indicating or confirming that AD conversion processing of a pixel signal, and/or signal processing after AD conversion processing, is performed appropriately and/or accurately, and/or or to methods of inspecting the solid-state imaging device.

According to some example embodiments of inventive concepts, a solid-state imaging device may include a pixel array comprising a plurality of pixels arranged oriented in a matrix; a pixel control unit configured to control operations of the plurality of pixels, the control of operations of the plurality of pixels including at least setting different exposure times for each pixel row of at least one pixel row of the pixel array; an analog-to-digital (AD) converter configured to perform AD conversion processing, the AD conversion processing including at least converting a pixel signal into a digital signal, the pixel signal being output from the pixel array, the pixel array including at least one pixel row exposed for different exposure times; and a data output unit configured to output the digital signal to the outside as image data.

According to some example embodiments of inventive concepts, a method of inspecting a solid-state imaging device, the solid-state imaging device comprising a pixel array and a ramp signal generation unit, the pixel array comprising a plurality of pixels arranged oriented in a matrix, the ramp signal generation unit configured to generate a non-linear ramp signal, may comprise controlling operations of the plurality of pixels, the controlling of operations including by setting different exposure times for each pixel row of at least one pixel row of the pixel array; performing analog-to-digital (AD) conversion processing on a pixel signal, the AD conversion processing including converting the pixel signal into a digital signal based on the non-linear ramp signal, the pixel signal being output from plurality of pixels, the plurality of pixels including pixels exposed for different exposure times based on the ramp signal; performing correction processing on the digital signal, the correction processing including correcting a non-linear output signal into a linear output signal with respect to the digital signal; and outputting the digital signal to the outside as image data after the correction processing.

According to some example embodiments of inventive concepts, a method of inspecting a solid-state imaging device, the solid state-imaging device comprising a pixel array and a ramp signal generation unit, the pixel array comprising a plurality of pixels oriented in a matrix, the and a ramp signal generation unit configured to generate a ramp signal, may comprise: controlling operations of the plurality of pixels, the controlling of operations of the plurality of pixels including at least setting different exposure times for each pixel row of at least one pixel row of the pixel array; performing analog-to-digital (AD) conversion processing on a pixel signal, the pixel signal being output from the pixels for each pixel row of at least one pixel row of the pixel array is exposed at different exposure times, the AD conversion processing being based on the ramp signal generated by the ramp signal generation unit; and outputting the pixel signal after the AD conversion processing to the outside as image data.

According to some example embodiments of inventive concepts, a method of imaging a subject using a solid state imaging device, the solid state image device including a pixel array, the pixel array including a plurality of pixels oriented in a matrix, may include performing a shutter operation on the pixel array, the shutter operation being successively performed on each pixel row from an initial pixel row to a last pixel row of the pixel array according to a certain time difference, performing a readout operation on the pixel array, the readout operation being successively performed on each pixel row from the first pixel row to the last pixel row of the pixel array according to the first time difference, performing analog-to-digital (AD) conversion on a pixel signal such that the pixel signal is converted to a digital signal, the pixel signal being output by the pixel array after the readout operation, performing correction processing on the digital signal, and outputting the corrected digital signal to the outside as image data, the image data including an image of the subject.

### BRIEF DESCRIPTION OF THE DRAWINGS

Example embodiments will be more clearly understood from the following detailed description taken in conjunction with the accompanying drawings in which:

FIG. 1 is a diagram illustrating a schematic configuration of a solid-state imaging device according to some example embodiments;

FIG. 2 is a diagram illustrating a configuration of a pixel according to some example embodiments;

FIG. 3 is a diagram illustrating components of an analog-to-digital (AD) converter according to some example embodiments;

FIG. 4 is a diagram illustrating an example of a waveform of a ramp signal generated by a ramp signal generation unit according to some example embodiments;

FIG. 5 is a diagram illustrating an imaging operation of a solid-state imaging device according to some example embodiments;

FIG. 6 is a diagram illustrating an inspection operation of a solid-state imaging device according to some example embodiments;

FIG. 7 is a diagram illustrating an example of an inspection image that may be obtained by the inspection operation described with reference to FIG. 6;

FIG. 8 illustrates an inspection image when correction processing after AD conversion processing is not appropriately performed, according to some example embodiments;

FIG. 9 is a diagram illustrating an inspection operation according to some example embodiments;

FIG. 10 is a diagram illustrating an example of an inspection image that may be obtained by the inspection operation described with reference to FIG. 9;

FIG. 11 is a diagram for explaining an inspection operation according to some example embodiments;

FIG. 12 is a diagram for explaining an example of an inspection image that may be obtained by the inspection operation described with reference to FIG. 11;

FIG. 13 is a diagram for explaining a start time of a shutter operation according to some example embodiments;

FIG. 14 is a diagram for explaining that an offset period is set between start times of a shutter operation and a readout operation, according to some example embodiments;

FIG. 15 is a diagram for illustrating a start time of a shutter operation according to some example embodiments;

FIG. 16 is a diagram for explaining how an offset period is set, according to some example embodiments;

FIG. 17 is a diagram for explaining an inspection operation in which different exposure times are set in a certain pixel row unit, according to some example embodiments;

FIG. 18 is a diagram for explaining an example of an inspection image that may be obtained by the inspection operation described with reference to FIG. 17;

FIG. 19 is a diagram for explaining an imaging operation of a solid-state imaging device, according to some example embodiments;

FIG. 20 is a diagram for explaining an inspection operation of a solid-state imaging device, according to some example embodiments;

FIG. 21 is a diagram for explaining an inspection operation in which an offset period is set, according to some example embodiments;

FIG. 22 is a diagram for explaining a start time of a shutter operation according to some example embodiments;

FIG. 23 is a diagram for explaining a start time of a readout operation according to some example embodiments;

FIG. 24 is a diagram for explaining that an offset period is set between start times of a shutter operation and a readout operation, according to some example embodiments;

FIG. 25 is a diagram for explaining a start time of a readout operation according to some example embodiments;

FIG. 26 is a diagram for explaining an inspection operation in which different exposure times are set in a certain pixel row unit, according to some example embodiments; and

FIG. 27 is a diagram for explaining an AD converter according to some example embodiments.

### DETAILED DESCRIPTION

Hereinafter, various example embodiments of inventive concept wills be described with reference to detail with reference to the drawings. In the drawings below, the same reference numerals refer to the same components, and redundant descriptions of these components will be omitted. The size of each component in the drawings may be exaggerated for clarity and convenience of explanation. In addition, example embodiments described below are merely examples, and various modifications are possible from these example embodiments.

Hereinafter, the expressions such as, for example, “upper,” “top”, or “above” include not only those directly above in contact, but also those directly above in non-contact (e.g., and not in contact). In addition, the expressions such as, for example, “upper,” “top”, or “above” may include not only those directly above/left/right in contact, but also those directly above/left/right in non-contact. Similarly, the parts described as, for example, “lower” or “below” may include not only those directly below/left/right in contact, but also those directly below/left/right in non-contact.

A singular expression may include a plural expression unless the context clearly indicates that it is singular. In addition, when a part is said to “include,” “comprise,” or “have” a component, it means that, unless there is a specific description to the contrary, it does not exclude other components but may include other components.

In addition, the terms such as “part,” “module,” etc. described with reference to the specification mean a unit that processes one or more functions or operations, which are implemented by hardware or software or by a combination of hardware and software.

In addition, “row” and “column” merely mean directions in which pixels, etc. are arranged (e.g., oriented), and the terms “row” and “column” may be interchangeable.

In addition, “simultaneously” may include or indicate not only completely identical in time, but also cases in which, although based on control intended to be “simultaneous,” the results of which are not completely identical in time due to the influence of unevenness of elements or parasitic elements, etc.

With respect to operations constituting a method, if the order is explicitly described or there is no description to the contrary, the operations are performed in the appropriate order. It is not necessarily limited to the order described with reference to the operations. Any use of examples or exemplary terms is intended merely to explain technical ideas and is not intended to limit the scope of the claims, unless otherwise specified.

In addition, when ordinal numbers such as “first” and “second” are used in the following description, they are used for convenience and do not prescribe any order, unless specifically stated otherwise.

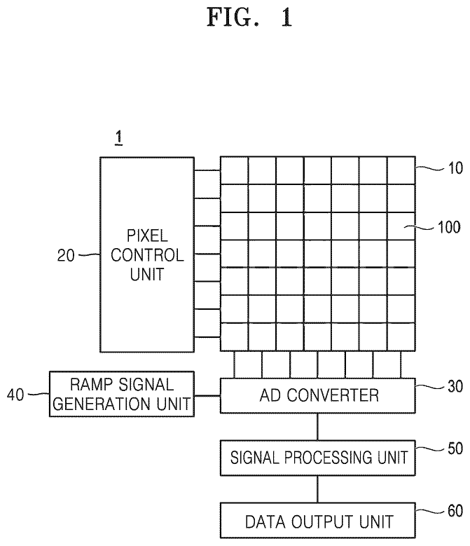

FIG. 1 is a diagram illustrating a schematic configuration of a solid-state imaging device according to some example embodiments.

Referring to FIG. 1, a solid-state imaging device 1 may include a pixel array 10, a pixel control unit 20, an analog-to-digital (AD) converter 30, a ramp signal generation unit 40, a signal processing unit 50, and/or a data output unit 60.

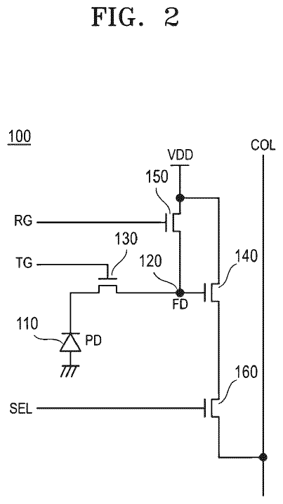

The pixel array 10 may include a plurality of pixels 100 arranged (e.g., oriented) in rows and columns. Each pixel 100 may include a photodiode and output an analog signal according to the amount of light received by the photodiode. The pixel 100 will be described with reference to detail with reference to FIG. 2.

The pixel control unit 20 controls the operation of the plurality of pixels 100. The pixel control unit 20 controls the operation of each pixel 100 by controlling the operation of a transistor in each pixel 100. The pixel control unit 20 may control the operation of the plurality of pixels 100 in a pixel row unit of the pixel array 10. For example, the pixel control unit 20 may control the operation of each pixel 100 in a row unit of the pixels 100 disposed horizontally in the pixel array 10. However, inventive concepts are not necessarily limited thereto.

The AD converter 30 may perform AD conversion processing to convert an analog signal output from the pixels 100 into a digital signal. For example, the analog signal output from the pixels 100 may be referred to as a pixel signal. The AD converter 30 may convert the analog signal into the digital signal (count value) by counting the time until the magnitude relationship between a ramp signal generated by the ramp signal generation unit 40 and the analog signal is inverted. For example, the AD converter 30 may use a clock signal, and may count the clock signal until the magnitude relationship between the ramp signal and the analog signal (pixel signal) is inverted and output the clock signal as the digital signal.

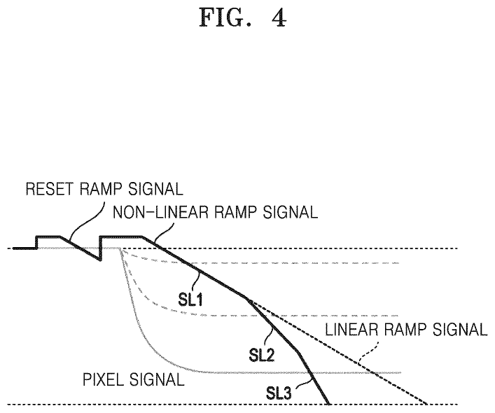

The ramp signal generation unit 40 may generate the ramp signal. The ramp signal generation unit 40 generates the ramp signal used for AD conversion processing. The ramp signal may be transmitted to the AD converter 30. In some example embodiments, the ramp signal generation unit 40 is a digital-to-analog conversion (DAC) circuit and may generate, for example, a non-linear ramp signal (e.g., a ramp signal (non-linear) in FIG. 4). Accordingly, the output signal (for example, the digital signal) after AD conversion processing by the AD converter 30 may have non-linear characteristics based on a non-linear ramp signal. For example, the digital signal, which is an output signal after AD conversion processing, may have non-linear characteristics.

The signal processing unit 50 may perform a signal processing operation on the digital signal after AD conversion processing. The signal processing unit 50 may correct the output signal having non-linear characteristics after AD conversion processing. For example, the signal processing unit 50 performs correction processing to correct the output signal of non-linear characteristics after AD conversion processing into an output signal, for example, an output signal having linear characteristics, when counted based on a linear ramp signal. The signal processing unit 50 may also, for example, perform correction on any errors inherently present in the AD converter 30.

The data output unit 60 outputs the digital signal after correction processing by the signal processing unit 50 to the outside of the solid-state imaging device 1 as image data. The data output unit 60 may sequentially output digital signals of the plurality of pixels 100 to the outside in a pixel row unit of the pixel array 10.

The solid-state imaging device 1 may further include components other than the pixel array 10, the pixel control unit 20, the AD converter 30, the ramp signal generation unit 40, the signal processing unit 50, and the data output unit 60 shown in FIG. 1, if necessary or desired. However, inventive concepts are not necessarily limited thereto, and some of the components shown in FIG. 1 may be omitted from the solid-state imaging device 1, if necessary or desired.

FIG. 2 is a diagram illustrating a configuration of a pixel according to some example embodiments. FIG. 2 is a circuit diagram illustrating a schematic configuration of the pixel 100. The pixel 100 of FIG. 2 may correspond to the pixel 100 described with reference to FIG. 1.

Referring to FIG. 2, a pixel 100 may include a photodiode (PD) 110, a floating diffusion (FD) 120, a transfer transistor 130, a source follower transistor 140, a reset transistor 150, and/or a selection transistor 160. However, inventive concepts are not necessarily limited thereto, and the pixel 100 may be variously implemented.

The PD 110 generates charges by photoelectrically converting incident light. The FD 120 accumulates the charges generated by the PD 110. The transfer transistor 130 controls the transmission of charges from the PD 110 to the FD 120. The source follower transistor 140 outputs a voltage of a magnitude according to the amount of charges accumulated by the FD 120. The reset transistor 150 may reset the charges of the floating diffusion 120. The selection transistor 160 controls transmission of the voltage output from the source follower transistor 140 to a column line COL.

Referring to FIGS. 1 and 2 together, the pixel control unit 20 controls the operation of each pixel 100 by controlling the transfer transistor 130, the reset transistor 150, and/or the selection transistor 160 of the pixel 100. For example, the pixel control unit 20 may control a shutter operation and a readout operation of the pixels 100 by controlling on/off of respective driving signals TG, RG, and SEL of the transfer transistor 130, the reset transistor 150, and the selection transistor 160. For example, the pixel control unit 20 may control the shutter operation and/or the readout operation of the pixel 100 by controlling the on/off of the driving signal TG of the transfer transistor 130, the driving signal RG of the reset transistor 150, and/or the driving signal SEL of the selection transistor 160.

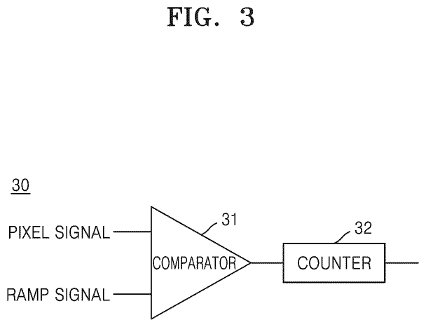

The shutter operation of a pixel 100 is an operation of (for example, including) resetting the PD 110 and the FD 120, and while the reset transistor 150 is in a turn-on state, the transfer transistor 130 is in a turn-on state. The readout operation of the pixel 100 is an operation of outputting a voltage signal of the magnitude according to the amount of charges accumulated by the photodiode 110 to the column line COL, and while the selection transistor 160 is in a turn-on state, the reset transistor 150 and the transfer transistor 130 are sequentially in a turn-on state. A period in which the transfer transistor 130 is in a turn-off state between the shutter operation and the readout operation may, for example, correspond to an exposure period in which the charges are accumulated in the PD110. Hereinafter, AD conversion processing performed by the AD converter 30 will be described with reference to FIGS. 3 and 4.

FIG. 3 is a diagram illustrating components of an AD converter according to some example embodiments. FIG. 3 illustrates the AD converter 30 of FIG. 1.

Referring to FIG. 3, the AD converter 30 may include a comparator 31 and/or a counter 32. A pixel signal and a ramp signal may be input to the comparator 31. The pixel signal (analog signal) may be input to one input terminal of the comparator 31. The pixel signal may be output from a pixel (e.g., the pixel 100 of FIG. 1). The ramp signal may be input to another input terminal of the comparator 31. The ramp signal may be generated by, for example, a ramp signal generation unit (e.g., the ramp signal generation unit 40 of FIG. 1).

The comparator 31 compares the magnitude of the pixel signal of the pixels 100 with that of the ramp signal generated by the ramp signal generation unit 40. The counter 32 counts the time until the magnitude relationship between the ramp signal generated by the ramp signal generation unit 40 and the pixel signal is inverted. The AD converter 30 may output a count value counted by the counter 32 until the magnitude relationship between the ramp signal and the pixel signal is inverted as a digital signal of (for example, based on) the pixel signal.

FIG. 4 is a diagram illustrating an example of a waveform of a ramp signal generated by a ramp signal generation unit according to some example embodiments.

Referring to FIG. 4, the ramp signal generation unit (e.g., the ramp signal generation unit 40 of FIG. 1) may generate a non-linear ramp signal having, for example, three straight lines SL1 to SL3 with different slopes (gains) after generating a reset ramp signal. For example, the ramp signal generation unit 40 may generate the straight line SL1, the straight line SL2, and the straight line SL3 in an order in which they are arranged. Compared to a case where a linear ramp signal is used, when a non-linear ramp signal is used in AD conversion processing, the time until (for example, the speed at which) the magnitude relationship between the ramp signal generated by the ramp signal generation unit 40 and the pixel signal is inverted may be accelerated, and the time required for AD conversion processing may be shortened.

An output signal (for example, digital signal) after AD conversion processing using the non-linear ramp signal may have weak linearity characteristics like the shape of the non-linear ramp signal. Accordingly, correction processing may be performed on the pixel signal after AD conversion processing (for example, on the digital signal) by a signal processing unit (e.g., the signal processing unit 50 of FIG. 1) so that the output signal (for example, the digital signal) has linear characteristics.

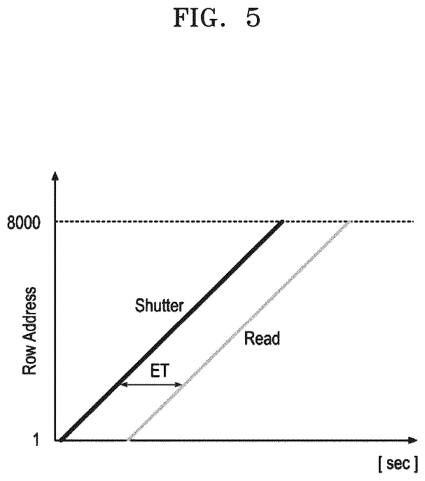

According to a solid-state imaging device according to some example embodiments (e.g., a solid-state imaging device according to FIG. 1), an inspection operation of outputting image data to check whether correction processing after AD conversion processing has been appropriately performed and/or accurately performed may be performed. In some example embodiments, the solid-state imaging device 1 according to some example embodiments may perform an imaging operation of imaging a subject and outputting image data. Hereinafter, an operation of the solid-state imaging device 1 will be described with reference to detail with reference to FIGS. 5 to 8.

FIG. 5 is a diagram illustrating an imaging operation of a solid-state imaging device according to some example embodiments. The imaging operation may mean an operation of a solid-state imaging device (e.g., a solid-state imaging device according to solid-state imaging device 1 of FIG. 1) imaging a subject and outputting image data.

Referring to FIG. 5, the vertical axis of FIG. 5 represents a row address of a pixel array (e.g., the pixel array 10 of FIG. 1), and the horizontal axis of FIG. 5 represents time (sec). The dark solid line (Shutter) in FIG. 5 indicates a start time of a shutter operation of each pixel row, and the light solid line (Read) indicates a start time of a readout operation of each pixel row. The shutter operation corresponds to an exposure start operation of the pixel 100, and the readout operation corresponds to an exposure end operation of the pixel 100. In some example embodiments, the solid-state imaging device 1 may operate in, for example, a rolling shutter method. However, inventive concepts are not limited thereto, and the solid-state imaging device 1 may operate in, for example, a global shutter method. The solid-state imaging device 1 operating in a rolling shutter method will be described with reference to FIGS. 5 to 18.

In the imaging operation of the solid-state imaging device 1 operating in a rolling shutter method, the shutter operation and/or readout operation may be sequentially performed for each pixel row at one or more certain time differences from an initial pixel row (e.g., row number: 1) to a last pixel row (e.g., row number: 8000) of the pixel array 10. After a certain exposure time ET has elapsed from the start time of the shutter operation, the readout operation may be sequentially performed for each pixel row from the initial pixel row (e.g., row number: 1) to the last pixel row (e.g., row number: 8000). FIG. 5 shows that 8000 pixel rows are included in the pixel array 10, but inventive concepts are not necessarily limited thereto, and the number of pixel rows may be variously implemented.

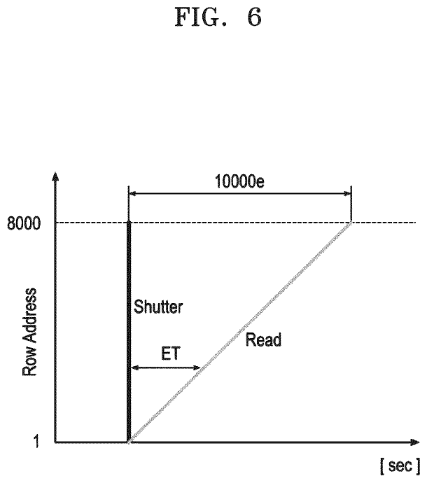

In the imaging operation of the solid-state imaging device 1 according to some example embodiments, exposure of the same exposure time ET is performed on all the pixels 100 while delaying an exposure start time for each pixel row at regular intervals from the initial pixel row to the last pixel row. For example, exposure of the same exposure time ET may be performed for each pixel row from the initial pixel row (e.g., row number: 1) to the last pixel row (e.g., row number: 8000). The pixel signal output from the pixel 100 after exposure may be output to the outside as image data by performing AD conversion processing and correction processing thereon. An image based on the image data is, for example, a general imaging image of a subject. Hereinafter, the inspection operation of the solid-state imaging device 1 will be described with reference to FIGS. 6 to 8.

FIG. 6 is a diagram illustrating an inspection operation of a solid-state imaging device according to some example embodiments. The inspection operation may mean an operation of outputting inspection image data. The inspection operation may be, for example, performed in a state in which uniform light is irradiated to the pixel array 10. Hereinafter, the inspection image data may be referred to as an inspection image.

The vertical axis of FIG. 6 represents a row address of the pixel array 10 and the horizontal axis represents time (sec). The dark solid line (Shutter) in FIG. 6 indicates a start time of a shutter operation of each pixel row, and the light solid line (Read) indicates a start time of a readout operation of each pixel row. The shutter operation corresponds to an exposure start operation of the pixel 100, and the readout operation corresponds to an exposure end operation of the pixel 100.

Referring to FIG. 6, in the inspection operation of the solid-state imaging device 1 according to some example embodiments, the shutter operation may be performed simultaneously on all pixel rows from the initial pixel row (e.g., row number: 1) to the last pixel row (e.g., row number: 8000). In some example embodiments, in the inspection operation of the solid-state imaging device 1, exposure of different exposure times ET may be performed on each pixel row from the initial pixel row to the last pixel row. The readout operation may be sequentially performed for each pixel row at a certain time difference from the initial pixel row to the last pixel row. For example, the exposure time ET with respect to the initial pixel row (e.g., row number: 1) may be shorter than the exposure time ET with respect to the last pixel row (e.g., row number: 8000). The shutter operation and the readout operation may be performed simultaneously on the initial pixel row, or substantially so.

In the inspection operation of the solid-state imaging device 1 according to some example embodiments, exposure may be started simultaneously on all pixel rows, and exposure at different exposure times ET may be performed for each pixel row while delaying the exposure end time for each pixel row at certain intervals from the initial pixel row to the last pixel row. For example, the exposure time ET of the pixel 100 of the initial pixel row may be 0, and the exposure time ET per certain time difference may be increased from the initial pixel row to the last pixel row. The exposure time ET of the pixel 100 in the last pixel row may be the longest.

Charges may not be accumulated or substantially accumulated or the amount of accumulated charges may be relatively small in the pixel 100 of the initial pixel row, and the amount of charges accumulated in the pixel 100 may increase from the initial pixel row to the last pixel row. For example, the maximum amount of charges equivalent to 10000e (corresponding to the highest luminance) may be accumulated in the pixel 100 of the last pixel row as an electron number conversion value. However, the above-described electron number conversion value may correspond to some example embodiments, but is not necessarily limited thereto.

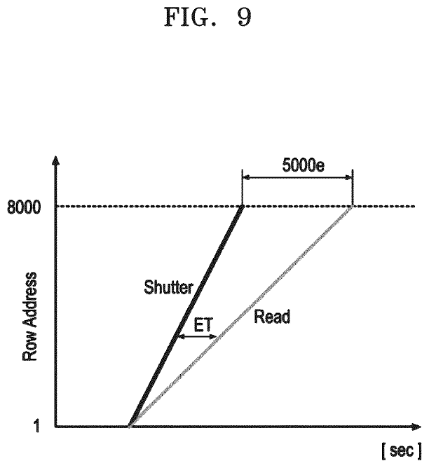

In some example embodiments, the exposure time of the pixel 100 may be changed according to a luminance range to be inspected. Some example embodiments in which the exposure time of the pixel 100 is changed will be described below with reference to FIGS. 9 to 18.

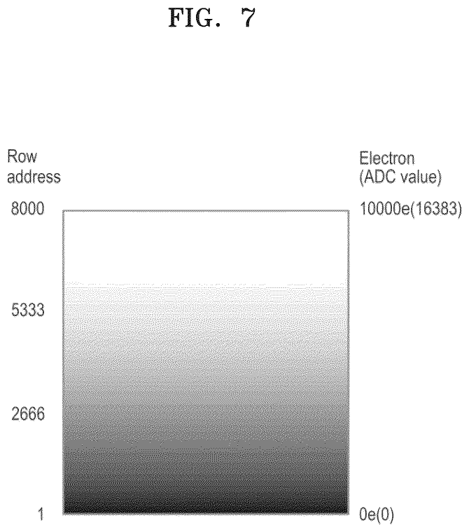

FIG. 7 is a diagram illustrating an example of an inspection image that may be obtained by an inspection operation described with reference to FIG. 6. As shown in FIG. 7, the inspection image may be a grayscale image (gradation image) in which the luminance (pixel value) increases straightly (linearly) from an initial pixel row to a last pixel row.

Referring to FIG. 7, it may be confirmed or indicated that in the inspection image, the luminance increases straightly (for example, linearly) from the initial pixel row to the last pixel row, and the inspection operation (e.g., the inspection operation described with reference to FIG. 6) that increases the exposure time ET straightly (for example, linearly) from the initial pixel row to the last pixel row is reflected (for example, indicated) on the inspection image. For example, according to the inspection image shown in FIG. 7, it may be indicated or confirmed that correction processing after AD conversion processing is appropriately performed such that an output signal after AD conversion processing has linearity characteristics.

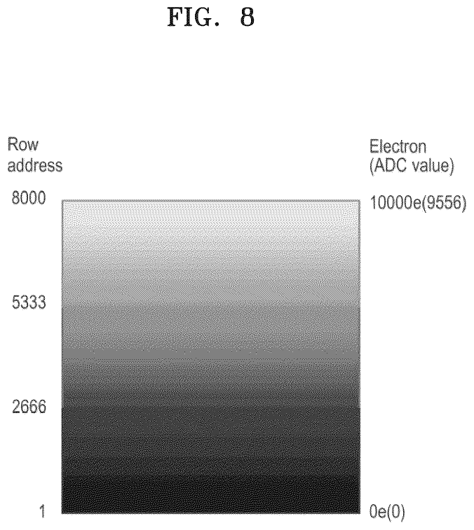

When correction processing after AD conversion processing is not appropriately performed, the luminance of the inspection image may not linearly increase. The inspection image when correction processing after AD conversion processing is not appropriately performed will be described with reference to FIG. 8.

FIG. 8 illustrates an inspection image when correction processing after AD conversion processing is not appropriately performed according to some example embodiments.

Referring to FIG. 8, the inspection image of FIG. 8 may not represent a grayscale image (gradation image) in which the luminance (pixel value) increases straightly (linearly) from an initial pixel row to a last pixel row. In the inspection image of FIG. 8, it may be indicated or confirmed that the luminance is changed non-straightly (non-linearly) in a number of places, and the exposure time ET of the inspection operation described with reference to FIG. 6 is not appropriately reflected on the inspection image, for example, correction processing after AD conversion processing is not appropriately performed.

Referring back to FIG. 7, the solid-state imaging device 1 according to some example embodiments may obtain a grayscale image (gradation image) having a different luminance for each pixel row by setting different exposure times ET for each pixel row in the inspection operation. For example, a grayscale image in which the luminance increases straightly (for example, linearly) from the initial pixel row to the last pixel row may be obtained by increasing the exposure time ET from the initial pixel row to the last pixel row. Accordingly, the solid-state imaging device 1 may relatively easily indicate or confirm at relatively low cost that correction processing after AD conversion processing of the pixel signal is appropriately performed.

Moreover, the solid-state imaging device 1 according to some example embodiments may perform inspection at a wafer stage before a product form such as a camera without mounting the solid-state imaging device 1 to the product form. Accordingly, the manufacturing yield of the solid-state imaging device 1 may be improved.

FIG. 9 is a diagram illustrating an inspection operation according to some example embodiments. In comparison with FIG. 6, in the inspection operation of FIG. 9, an exposure time of each pixel row may be set to, for example, half of a corresponding inspection time as in the inspection operation of FIG. 6.

Referring to FIG. 9, a shutter operation may be sequentially performed for each pixel row at a certain first time difference from an initial pixel row to a last pixel row. A readout operation may be sequentially performed for each pixel row at a certain second time difference from the initial pixel row to the last pixel row. In some example embodiments, the second time difference may be greater than the first time difference. For example, the shutter operation and the readout operation may be performed simultaneously with respect to the initial pixel row.

In the inspection operation of FIG. 9, the shutter operation and the readout operation of each pixel row may be sequentially performed so that the exposure time ET for each pixel row becomes, for example, half of that in the inspection operation of FIG. 6. As a result, charges may not be accumulated or substantially accumulated or relatively small charges may be accumulated in pixels in the initial pixel row (e.g., the pixel 100 in FIG. 1), and, for example, charges equivalent to 5000e may be accumulated as an electron number conversion value in the pixel 100 in the last pixel row. The amount of charges accumulated in the pixels 100 of the last pixel row according to the inspection operation of FIG. 9 may be less than the amount of charges accumulated in the pixels 100 of the last pixel row according to the inspection operation of FIG. 6.

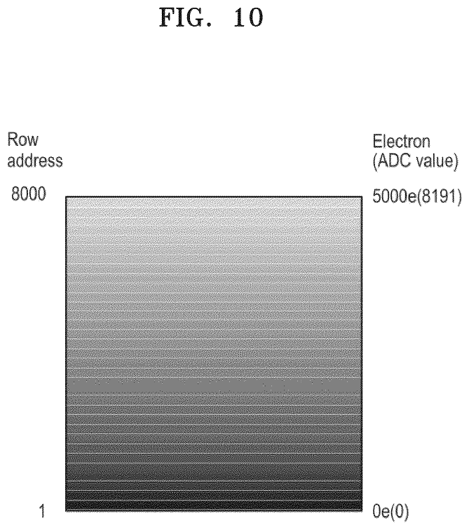

FIG. 10 is a diagram illustrating an example of an inspection image that may be obtained by an inspection operation described with reference to FIG. 9.

Referring to FIG. 10, the inspection image may be a grayscale image in which luminance increases straightly (for example, linearly) from an initial pixel row to a last pixel row. For example, in FIG. 10 a luminance change range may be a change range the same or similarly to as in the lower half of an inspection image shown in FIG. 7. It may be indicated or confirmed that an exposure time of the inspection operation described with reference to FIG. 9 is appropriately reflected on (for example, indicated by) the inspection image shown in FIG. 10.

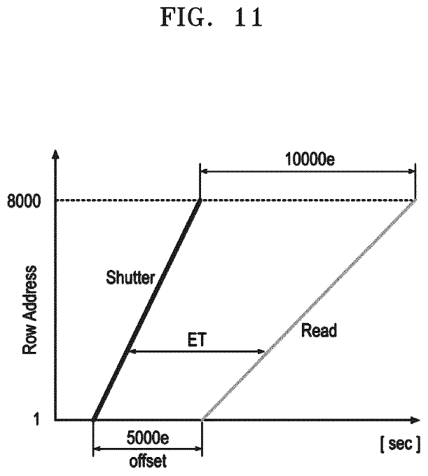

FIG. 11 is a diagram for explaining an inspection operation according to some example embodiments. In comparison with FIG. 9, in the inspection operation of FIG. 11, an offset period may be set in an inspection operation of FIG. 9.

Referring to FIG. 11, in the inspection operation of FIG. 11, a shutter operation may be sequentially performed for each pixel row at a certain first time difference from an initial pixel row to a last pixel row. A readout operation may be sequentially performed for each pixel row at a certain second time difference from the initial pixel row to the last pixel row. In some example embodiments, the second time difference may be greater than the first time difference. A certain offset period may be set between a start time of the shutter operation and a start time of the readout operation with respect to the initial pixel row.

In the inspection operation of FIG. 11, the offset period is set between the start time of the shutter operation and the start time of the readout operation with respect to the initial pixel row so that the exposure time ET for each pixel row is increased. As a result, for example, charges equivalent to 5000e may be accumulated in pixels in the initial pixel row (e.g., the pixel 100 in FIG. 1) as an electron number conversion value, and charges equivalent to 10000e may be accumulated in the pixel 100 of the last pixel row as an electron number conversion value. However, the electron number conversion value accumulated in each of the pixels of the initial pixel row and the pixels of the last pixel row is not necessarily limited thereto.

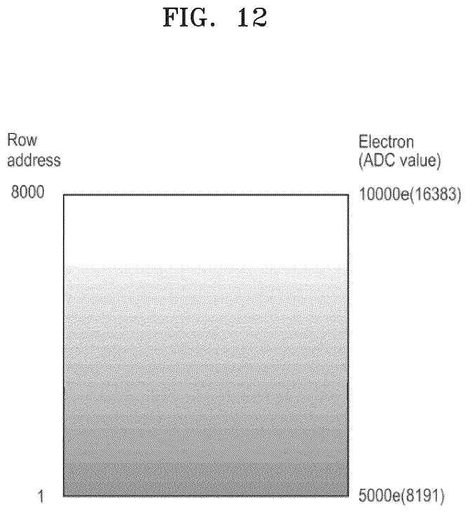

FIG. 12 is a diagram for explaining an example of an inspection image that may be obtained by an inspection operation described with reference to FIG. 11.

Referring to FIG. 12, the inspection image may be a grayscale image in which luminance increases straightly from an initial pixel row to a last pixel row. Here, a luminance change range may be a change range in the upper half of an inspection image shown in FIG. 7. It may be indicated or confirmed that an exposure time of the inspection operation described with reference to FIG. 11 is appropriately reflected on the inspection image shown in FIG. 12.

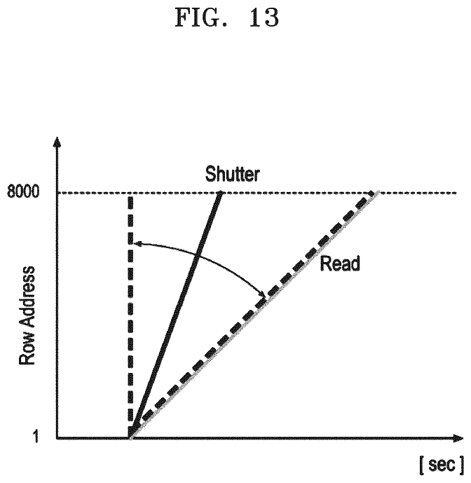

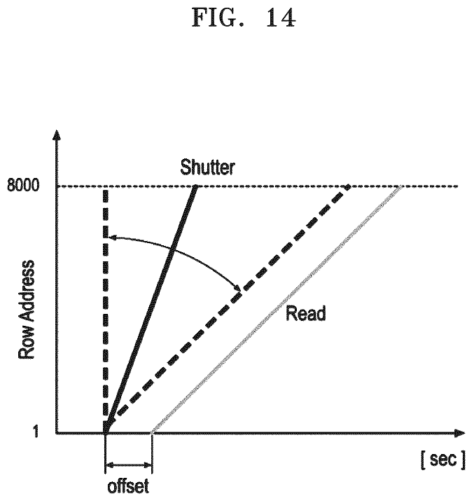

FIG. 13 is a diagram for explaining a start time of a shutter operation according to some example embodiments. FIG. 14 is a diagram for explaining that an offset period is set between start times of a shutter operation and a readout operation according to some example embodiments.

Referring to FIG. 13, a first time difference between pixel rows with respect to the start time of the shutter operation may be changed. In some example embodiments, the first time difference between pixel rows with respect to the start time of the shutter operation may be changed in a less range than a second time difference between pixel rows with respect to the start time of the readout operation. The first time difference between pixel rows with respect to the start time of the shutter operation may be changed within a range between two dark dashed lines shown in FIG. 13.

Referring to FIG. 14, the offset period may be set between the start time of the shutter operation and the start time of the readout operation. The first time difference between the pixel rows with respect to the start time of the shutter operation may be changed in a less range than the second time difference between the pixel rows with respect to the start time of the readout operation.

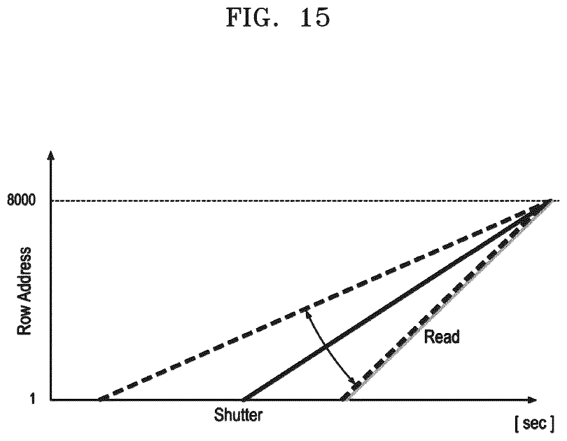

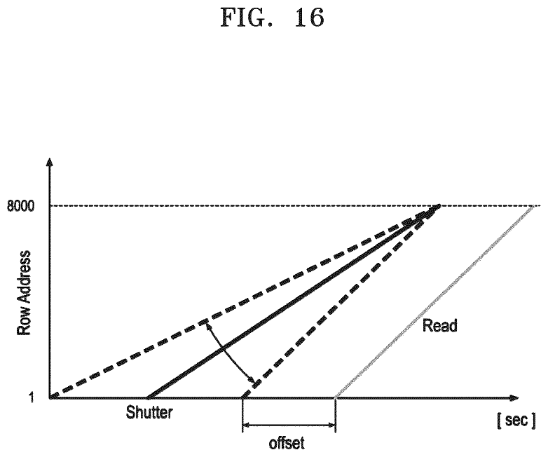

FIG. 15 is a diagram for illustrating a start time of a shutter operation according to some example embodiments. FIG. 16 is a diagram for explaining how an offset period is set according to some example embodiments.

Referring to FIG. 15, a first time difference between pixel rows with respect to the start time of the shutter operation may be changed. In some example embodiments, the first time difference between pixel rows with respect to the start time of the shutter operation may be changed in a greater range than a second time difference between pixel rows with respect to a start time of a readout operation. The first time difference between pixel rows with respect to the start time of the shutter operation may be changed within a range between two dark dashed lines shown in FIG. 15. For example, in the inspection operation of FIG. 15, in a last pixel row (e.g., row number: 8000), the start time of the shutter operation and the start time of the readout operation may coincide. For example, in the last pixel row, the exposure time ET may be 0 or relatively short.

Referring to FIG. 16, an offset period may be set between the start time of the shutter operation and the start time of the readout operation. The first time difference between the pixel rows with respect to the start time of the shutter operation may be changed in a greater range than the second time difference between the pixel rows with respect to the start time of the readout operation.

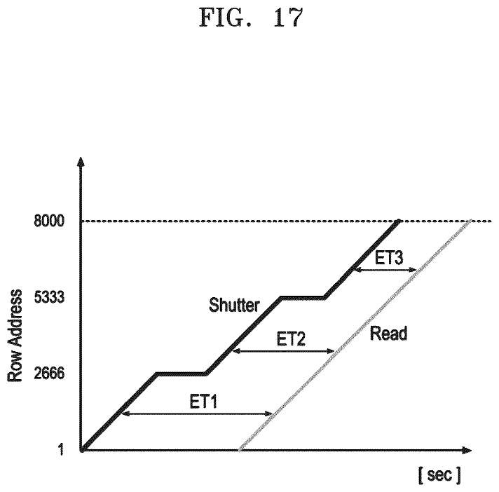

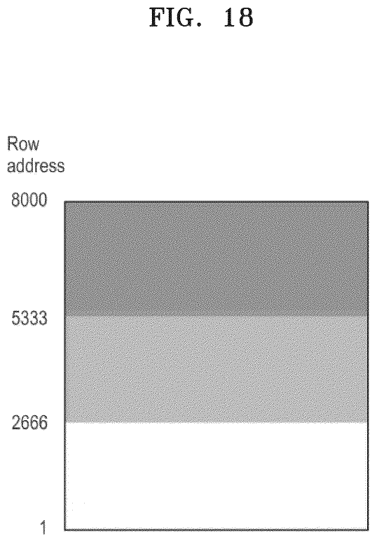

In some example embodiments, in an inspection operation of a solid-state imaging device (e.g., solid-state imaging device 1 in FIG. 1), different exposure times may be set for one pixel row unit. For example, in the inspection operation of the solid-state imaging device 1, different exposure times may be set for each pixel row. It has been described with reference to FIGS. 6 to 15 above that different exposure times are set in one pixel row unit of a pixel array (e.g., the pixel array 10 of FIG. 1). However, inventive concepts are not necessarily limited, and in the inspection operation of the solid-state imaging device 1, different exposure times may be set in a certain pixel row unit. Hereinafter, embodiments in which different exposure times are set in a certain pixel row unit will be described with reference to FIGS. 17 and 18.

FIG. 17 is a diagram for explaining an inspection operation in which different exposure times are set in a certain pixel row unit according to some example embodiments.

The vertical axis of FIG. 17 represents a row address of the pixel array 10 and the horizontal axis represents time (sec). The dark solid line (Shutter) in FIG. 17 indicates a start time of a shutter operation of each pixel row, and the light solid line (Read) indicates a start time of a readout operation of each pixel row. The shutter operation corresponds to an exposure start operation of the pixel 100, and the readout operation corresponds to an exposure end operation of the pixel 100.

Referring to FIG. 17, in an inspection operation of a solid-state imaging device (e.g., the solid-state imaging device 1 of FIG. 1), the shutter operation may be performed sequentially on all pixel rows from an initial pixel row (e.g., row number: 1) to a last pixel row (e.g., row number: 8000).

In some example embodiments, pixel rows from the initial pixel row to the last pixel row may be grouped in a certain pixel row unit, and pixel rows included in different groups may be exposed at different exposure times ET. Exposure of the same exposure time ET may be performed on each of the pixel rows included in the same group.

For example, in the inspection operation of FIG. 17, different exposure times are set for each ⅓ pixel row of all pixel rows, and exposure may be performed for each pixel row. For example, the initial pixel row (e.g., row number: 1) to a 2666th pixel row may correspond to a first group, and exposure of a first exposure time ET1 may be performed on the pixel rows included in the first group. A 2667th pixel row to a 5333th pixel row may correspond to a second group, and exposure of a second exposure time ET2 may be performed on the pixel rows included in the second group. The second exposure time ET2 may be shorter than the first exposure time ET1. In addition, a 5334th pixel row to a 8000th pixel row may correspond to a third group, and exposure of a third exposure time ET3 may be performed on the pixel rows included in the third group. The third exposure time ET3 may be shorter than the second exposure time ET2.

In some example embodiments, exposure may be started sequentially from the initial pixel row of each group at a certain time difference with respect to a plurality of pixel rows included in each group, and exposure may be performed for a certain time between groups. In FIG. 17, it has been described that pixel rows are grouped into three groups, but this is an example, and pixel rows may be grouped into various numbers of groups.

FIG. 18 is a diagram for explaining an example of an inspection image that may be obtained by an inspection operation described with reference to FIG. 17.

Referring to FIG. 18, the inspection image is a grayscale image having three luminance levels. It may be indicated and/or confirmed that an exposure time of the inspection operation described with reference to FIG. 17 is appropriately reflected on the inspection image shown in FIG. 18.

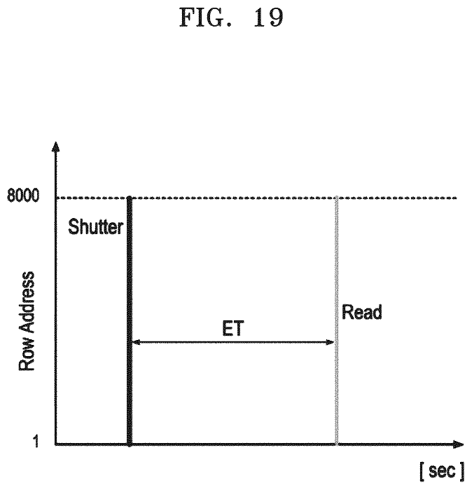

FIG. 19 is a diagram for explaining an imaging operation of a solid-state imaging device according to some example embodiments. Referring to FIG. 19, the vertical axis of FIG. 19 represents a row address of a pixel array (e.g., the pixel array 10 of FIG. 1), and the horizontal axis of FIG. 19 represents time (sec). The dark solid line (Shutter) in FIG. 19 indicates a start time of a shutter operation of each pixel row, and the light solid line (Read) indicates a start time of a readout operation of each pixel row.

In some example embodiments, the solid-state imaging device (e.g., the solid-state imaging device 1 of FIG. 1) may operate in a global shutter method. In the solid-state imaging device 1 operating in the global shutter method, a shutter operation and a readout operation may be, respectively, simultaneously performed on all pixels. The shutter operation corresponds to an exposure start operation of the pixel 100, and the readout operation corresponds to an exposure end operation of the pixel 100. The readout operation refers to an operation of latching a pixel signal.

Referring to FIG. 19, in an imaging operation of the solid-state imaging device 1 operating in the global shutter method, the shutter operation may be performed simultaneously on all pixel rows from an initial pixel row (e.g., row number: 1) to a last pixel row (e.g., row number: 8000). After a certain exposure time ET has elapsed from the start time of the shutter operation, the readout operation may be performed simultaneously on all pixel rows.

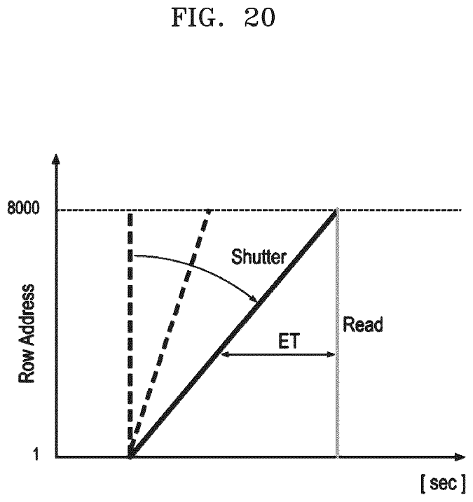

In the imaging operation of the solid-state imaging device 1 according to some example embodiments, exposure is started simultaneously and exposure ends simultaneously with respect to all pixel rows, and accordingly exposure of the same exposure time ET is performed on all the pixels 100. Hereinafter, an inspection operation of the solid-state imaging device 1 will be described with reference to FIG. 20.

FIG. 20 is a diagram for explaining an inspection operation of a solid-state imaging device according to some example embodiments. The vertical axis of FIG. 20 represents a row number (Row Address) of the pixel array (e.g., the pixel array 10 of FIG. 1), and the horizontal axis represents the time (sec). The dark solid line (Shutter) in FIG. 20 indicates a start time of a shutter operation of each pixel row, and the light solid line (Read) indicates a start time of a readout operation of each pixel row. The shutter operation corresponds to an exposure start operation of the pixel 100, and the readout operation corresponds to an exposure end operation of the pixel 100. The readout operation refers to an operation of latching a pixel signal.

Referring to FIG. 20, in the inspection operation of the solid-state imaging device (e.g., the solid-state imaging device 1 of FIG. 1) according to some example embodiments, like an imaging operation, the readout operation may be performed simultaneously on all pixel rows from an initial pixel row (e.g., row number: 1) to a last pixel row (e.g., row number: 8000). The shutter operation may be sequentially performed for each pixel row at a certain time difference from the initial pixel row to the last pixel row. For example, the exposure time ET with respect to the initial pixel row (e.g., row number: 1) may be longer than the exposure time ET with respect to the last pixel row (e.g., row number: 8000). The shutter operation and the readout operation may be performed simultaneously on the last pixel row. A time difference of the shutter operation between the pixel rows may be appropriately set.

In the inspection operation of the solid-state imaging device 1 according to some example embodiments, exposure of different exposure times ET for each pixel row may be performed by simultaneously ending exposure with respect to all pixel rows while delaying the exposure start time for each pixel row at regular intervals. For example, the exposure time ET of the pixel 100 in the initial pixel row is the longest, and the exposure time ET per certain time difference is shortened from the initial pixel row to the last pixel row. The exposure time ET of the pixel 100 in the last pixel row may be 0 or relatively short. The exposure time ET of the initial pixel 100 may be the longest. A grayscale image in which luminance decreases straightly from the initial pixel row to the last pixel row may be obtained.

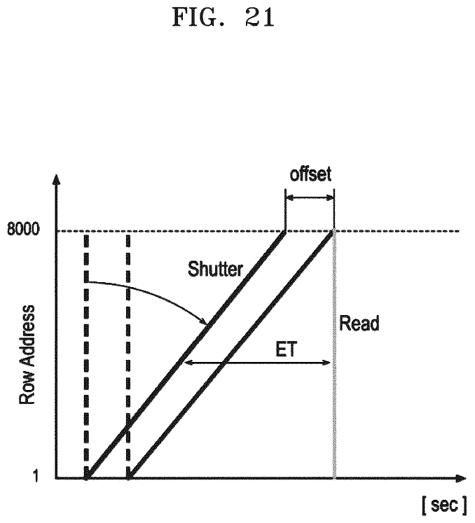

FIG. 21 is a diagram for explaining an inspection operation in which an offset period is set according to some example embodiments. In the inspection operation of FIG. 21, the offset period may be set in an inspection operation of FIG. 10.

In the inspection operation of FIG. 21, the offset period may be set in a last pixel row. Specifically, the offset period may be set between a start time of a shutter operation and a start time of a readout operation with respect to the last pixel row. In some example embodiments, the exposure time may be changed according to a luminance range to be inspected.

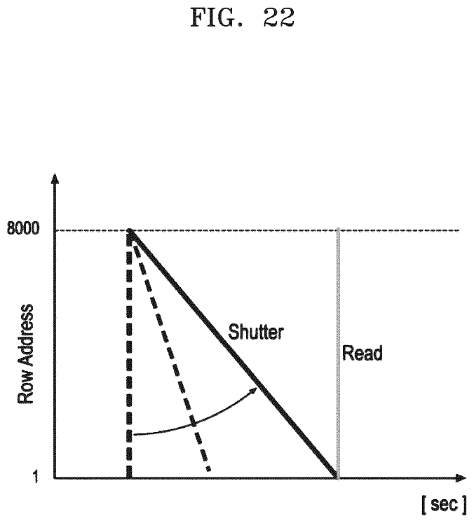

FIG. 22 is a diagram for explaining a start time of a shutter operation according to some example embodiments.

Referring to FIG. 22, the shutter operation may be sequentially performed from a last pixel row to an initial pixel row. That is, from the last pixel row to the initial pixel row, exposure may be started first at a certain time difference. The time difference of the shutter operation between the pixel rows may be appropriately set.

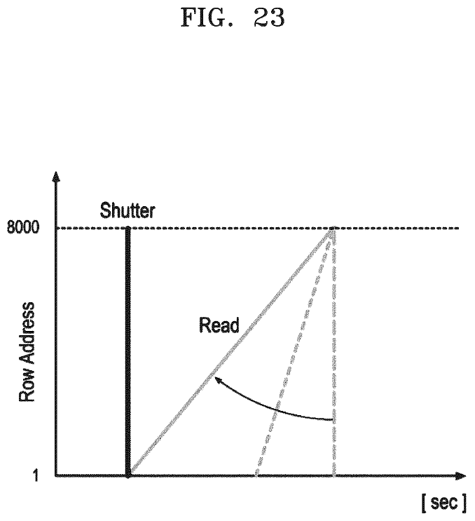

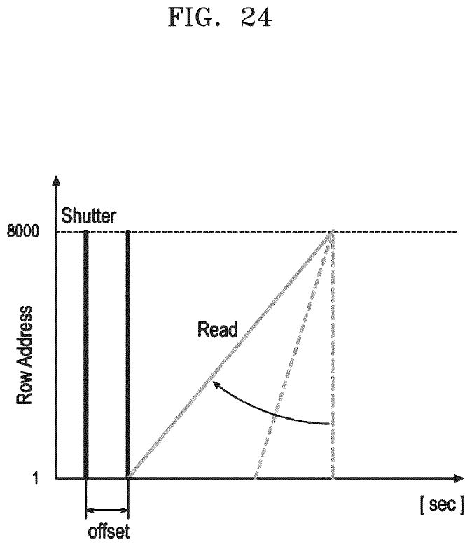

FIG. 23 is a diagram for explaining a start time of a readout operation according to some example embodiments. FIG. 24 is a diagram for explaining that an offset period is set between start times of a shutter operation and a readout operation according to some example embodiments.

Referring to FIG. 23, the solid-state imaging device 1 simultaneously performs the shutter operation on all pixel rows according to a global shutter method, and the start time of the readout operation may be changed.

For example, as shown in FIG. 23, from an initial pixel row to a last pixel row, the readout operation may be performed sequentially at a certain time difference for each pixel row.

Referring to FIG. 24, the offset period may be set between the start time of the shutter operation and the start time of the readout operation. The offset period may be set between the start time of the shutter operation and the start time of the readout operation with respect to the last pixel row.

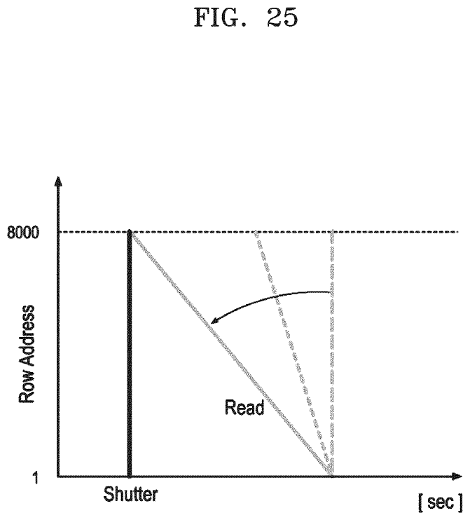

FIG. 25 is a diagram for explaining a start time of a readout operation according to some example embodiments.

In comparison with FIG. 23, in FIG. 25, the readout operation may be sequentially performed at a certain time difference for each pixel row from a last pixel row to an initial pixel row. In some example embodiments, the readout operation may be sequentially performed from the last pixel row to the initial pixel row. For example, from the last pixel row to the initial pixel row, exposure may end first at a certain time difference. The time difference of the readout operation between the pixel rows may be appropriately set.

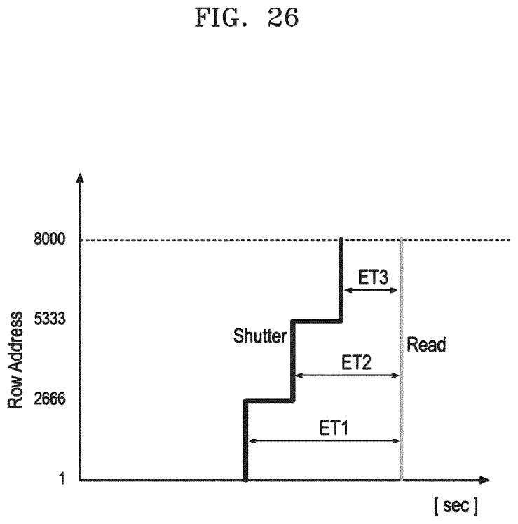

FIG. 26 is a diagram for explaining an inspection operation in which different exposure times are set in a certain pixel row unit according to some example embodiments. The vertical axis of FIG. 26 represents a row address of a pixel array (e.g., the pixel array 10 of FIG. 1), and the horizontal axis represents the time (sec).

In some example embodiments, pixel rows from an initial pixel row to a last pixel row may be grouped in a certain pixel row unit, and pixel rows included in different groups may be exposed at different exposure times ET. Exposure of the same exposure time ET may be performed on each of the pixel rows included in the same group.

Referring to FIG. 26, in an inspection operation of the solid-state imaging device 1, a shutter operation may be simultaneously performed on pixel rows grouped into the same group. However, inventive concepts are not necessarily limited thereto. The shutter operation may be sequentially performed on pixel rows from the initial pixel row (e.g., row number: 1) to the last pixel row (e.g., row number: 8000).

In the inspection operation of FIG. 26, different exposure times are set for each ⅓ pixel row of all pixel rows, and exposure may be performed for each ⅓ pixel row. For example, the initial pixel row (e.g., row number: 1) to the 2666th pixel row may correspond to a first group, and the shutter operation may be performed simultaneously on the pixel rows grouped into the first group. Exposure of the first exposure time ET1 may be performed on the pixel rows included in the first group. The 2667th pixel row to the 5333th pixel row may correspond to a second group, and the shutter operation may be performed simultaneously on the pixel rows grouped into the second group. Exposure of a second exposure time ET2 may be performed on the pixel rows included in the second group. The second exposure time ET2 may be shorter than the first exposure time ET1. In addition, the 5334th pixel row to the 8000th pixel row may correspond to a third group, and the shutter operation may be performed simultaneously on the pixel rows grouped into the third group. Exposure of a third exposure time ET3 may be performed on the pixel rows included in the third group. The third exposure time ET3 may be shorter than the second exposure time ET2.

The shutter operation and the readout operation may be performed simultaneously on a plurality of pixel rows included in each group. By the inspection operation described with reference to FIG. 26, a grayscale image having three luminance levels may be obtained as the inspection image. In FIG. 26, it has been described that pixel rows are grouped into three groups, but example embodiments are not limited thereto, and pixel rows may be grouped into various numbers of groups.

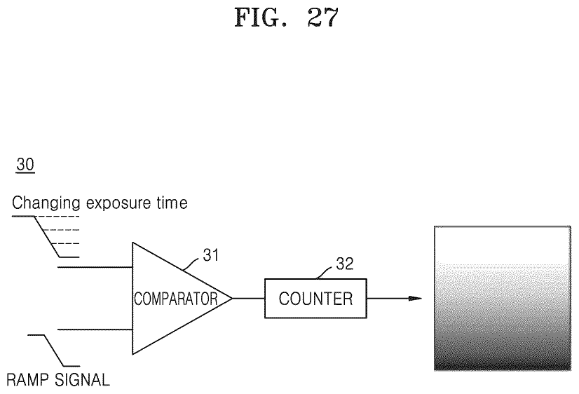

FIG. 27 is a diagram for explaining an AD converter according to some example embodiments. The descriptions given with reference to FIGS. 1 to 26 may be applied to a linearity inspection of a linear ramp signal in FIG. 27.

In FIG. 27, a method of inspecting a solid-state imaging device (e.g., the solid-state imaging device 1 of FIG. 1) will be described. Referring to FIG. 27, the AD converter 30 may include the comparator 31 and/or the counter 32. A linear ramp signal including one straight line may be input to one input terminal of the comparator 31 constituting the AD converter 30.

For example, a pixel signal (analog signal) output from an exposed pixel at different exposure times for each pixel row may be input to the other input terminal of the comparator 31. The pixel signal is converted into a digital signal using a ramp signal, correction processing such as, for example, error correction is performed, and then output to the outside as image data.

An inspection image based on the image data is, for example, a grayscale image in which grayscale (luminance) changes for each pixel row. When the ramp signal has a linearity characteristic, the luminance of the grayscale image may linearly change. Accordingly, according to the method of inspecting the solid-state imaging device 1 according to some example embodiments, the linearity characteristics of the ramp signal may be relatively easily checked at relatively low cost.

Inventive concepts are not limited to examples embodiments described with reference to FIGS. 1 to 27, and may be variously changed within the scope of the claims as understood by one of ordinary skill in the art.

For example, in example embodiments described with reference to FIGS. 1 to 26, AD conversion processing is performed using a non-linear ramp signal including three straight lines (e.g., the three straight lines SL1 to SL3 in FIG. 4). However, the non-linear ramp signal is not limited to a ramp signal including a plurality of straight portions, but may also be a ramp signal including one or more curved portions.

In addition, in example embodiments described with reference to FIGS. 1 to 27, different exposure times are implemented for each pixel row by partially changing operations of pixels of the solid-state imaging device on the premise of a rolling shutter or global shutter type solid-state imaging device. However, the configuration of the pixel is not limited to the premise of the rolling shutter or global shutter type solid-state imaging device, and the pixel of various circuit configurations may be used.

While inventive concepts have been particularly shown and described with reference to various example embodiments thereof, it will be understood by one of ordinary skill in the art that various changes in form and details may be made therein without departing from the spirit and scope of the following claims.

One or more of the elements disclosed above may include or be implemented in one or more processing circuitries such as hardware including logic circuits; a hardware/software combination such as a processor executing software; or a combination thereof. For example, the processing circuitries more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

What is claimed is:

1. A solid-state imaging device, comprising:
a pixel array comprising a plurality of pixels oriented in a matrix;
a pixel control unit configured to control operations of the plurality of pixels, the control of operations of the plurality of pixels including at least setting different exposure times for each pixel row of at least one pixel row of the pixel array;
an analog-to-digital (AD) converter configured to perform AD conversion processing, the AD conversion processing including at least converting a pixel signal into a digital signal, the pixel signal being output from the pixel array, the pixel array including at least one pixel row exposed for different exposure times; and
a data output unit configured to output the digital signal to the outside as image data.

2. The solid-state imaging device of claim 1, wherein the solid-state imaging device is configured such that an image based on the image data has a different grayscale for each pixel row of the at least one pixel row.

3. The solid-state imaging device of claim 1, wherein the pixel array includes an initial pixel row to a last pixel row, and
the pixel control unit is configured to control the operations of the plurality of pixels such that exposure time successively increases or decreases for each pixel row of the at least one pixel row from the initial pixel row to the last pixel row of the pixel array.

4. The solid-state imaging device of claim 1, wherein the pixel control unit is configured to control the operations of the plurality of pixels such that exposure starts simultaneously for each pixel row of the at least one pixel row of the pixel array.

5. The solid-state imaging device of claim 1, wherein the pixel control unit is configured to control the operations of the plurality of pixels such that exposure starts at different times for each pixel row of the at least one pixel row of the pixel array.

6. The solid-state imaging device of claim 5, wherein the pixel control unit is configured to control the operations of the plurality of pixels such that exposure starts at different times for each pixel row of the at least one pixel row of the pixel array according to a time interval for each certain pixel row.

7. The solid-state imaging device of claim 1, wherein the pixel control unit is configured to control the operations of the plurality of pixels by setting an offset period between an exposure start time and an exposure end time.

8. The solid-state imaging device of claim 1, wherein the pixel control unit is configured to control the operations of the plurality of pixels such that exposure starts successively later by a first time difference from an initial pixel row to a last pixel row of the pixel array, or exposure starts successively earlier by the first time difference from the initial pixel row to the last pixel row of the pixel array.

9. The solid-state imaging device of claim 8, wherein the pixel control unit is configured to set the first time difference.

10. The solid-state imaging device of claim 1, wherein the pixel control unit is configured to control the operations of the plurality of pixels such that exposure ends successively later by a second time difference from an initial pixel row to a last pixel row of the pixel array, or exposure ends successively earlier by the second time difference from the initial pixel row to the last pixel row of the pixel array.

11. The solid-state imaging device of claim 10, wherein the pixel control unit is configured to set the second time difference.

12. The solid-state imaging device of claim 1, further comprising:
a signal processing unit configured to perform signal processing on the digital signal,
wherein the data output unit is configured to output the digital signal to the outside after the signal processing by the signal processing unit.

13. The solid-state imaging device of claim 12, wherein
the AD converter has a non-linear output characteristic, and
the signal processing unit is configured to perform correction processing, the correction processing including correcting the non-linear output characteristic to a linear output characteristic with respect to the pixel signal.

14. A method of inspecting a solid-state imaging device, the solid-state imaging device comprising a pixel array and a ramp signal generation unit, the pixel array comprising a plurality of pixels oriented in a matrix, the ramp signal generation unit configured to generate a non-linear ramp signal, the method comprising:
controlling operations of the plurality of pixels, the controlling of operations of the plurality of pixels including at least setting different exposure times for each pixel row of at least one pixel row of the pixel array;
performing analog-to-digital (AD) conversion processing on a pixel signal, the AD conversion processing including converting the pixel signal into a digital signal based on the non-linear ramp signal, the pixel signal being output from plurality of pixels, the plurality of pixels including pixels exposed for different exposure times;
performing correction processing on the digital signal, the correction processing including correcting a non-linear output signal into a linear output signal with respect to the digital signal; and
outputting the digital signal to the outside as image data after the correction processing.

15. The method of claim 14, wherein
the non-linear ramp signal is a ramp signal including a plurality of straight lines, and
the correction processing includes correcting a pixel signal based on the plurality of straight lines to a pixel signal based on one straight line.

16. The method of claim 14, wherein
an image based on the image data has a different grayscale for each pixel row of the at least one pixel row of the pixel array, and
an inspection operation of the correction processing is performed based on the image data.

17. The method of claim 14, wherein the controlling of the operations of the plurality of pixels includes controlling the operations of the plurality of pixels such that the exposure time successively increases for each pixel row of the at least one pixel row of the pixel array from an initial pixel row to a last pixel row of the pixel array.

18. The method of claim 14, wherein the controlling of the operations of the plurality of pixels includes controlling the operations of the plurality of pixels so that the exposure time successively decreases for each pixel row of the at least one pixel row of the pixel array from an initial pixel row to a last pixel row of the pixel array.

19. A method of inspecting a solid-state imaging device, the solid state-imaging device comprising a pixel array and a ramp signal generation unit, the pixel array comprising a plurality of pixels oriented in a matrix, the ramp signal generation unit configured to generate a ramp signal, the method comprising:
controlling operations of the plurality of pixels, the controlling of operations of the plurality of pixels including at least setting different exposure times for each pixel row of at least one pixel row of the pixel array;
performing analog-to-digital (AD) conversion processing on a pixel signal, the pixel signal being output from pixels for each pixel row of at least one pixel row of the pixel array is exposed for different exposure times, the AD conversion processing being based on the ramp signal generated by the ramp signal generation unit; and
outputting the pixel signal after the AD conversion processing to the outside as image data.

20. The method of claim 19, wherein
an image based on the image data has a different grayscale for each pixel row of the at least one pixel row of the pixel array, and
a linearity inspection of the ramp signal is performed based on the image data.
